(19) United States
(12) Patent Application Publication
(10) Pub. No.: US 2019/0391049 A1
(43) Pub. Date: Dec. 26, 2019

(54) Smart Rail Wheelset Bearing

(71) Applicant: The Charles Stark Draper Laboratory, Inc., Cambridge, MA (US)

(72) Inventor: Troy B. Jones, Richmond, VA (US)

(21) Appl. No.: 16/015,449

(22) Filed: Jun. 22, 2018

(51) Int. Cl. G01M 17/10; G01M 5/00

(52) U.S. Cl. CPC G01M 17/10; G01M 5/0058

(57) ABSTRACT

In some embodiments, a method (and system) may include measuring data points within (or on) a wheelset environment. The wheelset environment may be local to a wheelset of a train. The method (and system) may compare a signature of the data points of the wheelset environment to an expected signature. The expected signature may represent a baseline of normal operations within a rail environment. The method (and system) may determine a condition within the rail environment responsive to the comparison of the signature to the expected signature.

### BACKGROUND

Trains, which include locomotives and railroad cars, are used for frequent transportation across the world. Such railroad cars are attached to frame assemblies beneath each end of the railroad car. These frame assemblies include wheelsets, which are a wheel-axle assembly. Wheelsets can be interchangeable between trains.

### SUMMARY

There is a need in railroads and railroad cars for a sensing system and method for predicting or detecting changing conditions or failures occurring on or around trains, train tracks, or rail trains, with minimal changes to other infrastructure. Embodiments as described herein are directed to such an improvement.

In an embodiment, a method measures data points within (or on) a wheelset environment. The wheelset environment may be local to a wheelset of a train. The method may compare a signature of the data points of the wheelset environment to an expected signature. The expected signature may represent a baseline of normal operations within a rail environment. The method may determine a condition within the rail environment responsive to the comparison of the signature to the expected signature. The method may communicate the determined condition to one or more devices across a network

In an embodiment, the condition may be a fault within the rail environment. The condition may include an actual failure (e.g., an existing failure or a failure that has occurred), a potential failure, signature deviating from the expected signature over a threshold, or a frequency spectra of acquired vibration or acoustic data.

In an embodiment, a signature may include frequency spectra of data points (such as the acquired vibration and acoustic data). The threshold may include changes in frequency content or power levels of the frequencies.

In an embodiment, the threshold may be a static threshold (level), a dynamic threshold, or a combination of a dynamic threshold and a static threshold. In an embodiment, the threshold is a dynamic threshold, which may change over time based upon one or more functions. In an embodiment, the threshold may be based upon an average value, such as a bearing temperature.

In an embodiment, the condition may be a fault within the rail environment. The condition may include an actual failure (e.g., an existing failure or a failure that has occurred), a potential failure, or signature deviating from the expected signature over a threshold.

In an embodiment, the signature may include but is not limited to including frequency spectra of a time history of vibration, acoustic data points, average values or the rate of change of data points for any quantity being measured. Quantities being measured may include but are not limited to including temperature, pressure, or other quantities being measure over time, or any other quantities known to one skilled in the art to detect for vibration (or acoustic data) over time.

The potential failure may include a recommendation of maintenance or predicted failure.

In embodiments, the fault within the rail environment may include a failure of a bearing of the wheelset, a failure of a wheel of the wheelset, a failure of a rail or weld of a track in contact with the train, a misaligned geometry of the track in contact with the train, a derailment of a wheelset, or a failure of an axle of the wheelset.

In some embodiments, the data points of the wheelset may include one or more of: an acoustic signal (e.g., sound signal level), a vibration signal (e.g., acceleration or vibration level), a rotation (e.g., orientation, rotational signal, or rotational rate) of an axle of the wheelset, a temperature, an atmospheric pressure, a time, a location (e.g., geographic location) of the wheelset; and a velocity (or speed) of the wheelset. In some embodiments, the wheelset environment may include a history of one or more of the data points.

In some embodiments, the method may correlate the expected signature to location data. In some embodiments, the method may diagnose faults within the wheelset environment associated with one or more sensors. The method may perform the measuring by the one or more sensors. The method may perform the diagnosing based upon loss of at least one message or signal sent to or received from an external source.

Vibration may include mechanical vibration. In embodiments, the method may the method may measure or detect vibration before detecting acoustic signals. The method may detect acoustic signals through the air. The method may detect vibration or acoustic signals by a microphone.

In embodiments, the method may harvest power based upon a rotation of an axle of the wheelset. The harvested power may enable one or more of the measuring, the comparing, the communicating, and the determining. In some embodiments, the method may harvest power based upon a self-contained power generator enclosed within a housing (e.g., end cap or bearing end cap) of a bearing of the wheelset. In some embodiments, the method may harvest power based upon a power generator comprised of a rotor (e.g., magnets) and a stator (e.g., coils). The rotor and stator may be included in an outer housing of a bearing of the wheelset.

In an embodiment, a system may include a sensor configured to measure data points of a wheelset environment. The wheelset environment may be local to a wheelset of a train. The system may include a processor, or a memory with computer code instructions stored therein. The memory may be operatively coupled to the processor such that the computer code instructions may configure the processor to compare a signature of the data points of the wheelset environment to an expected signature. The expected signature may represent a baseline of normal operations within a rail environment. The processor may determine a condition within the rail environment responsive to the comparison of the signature to the expected signature. The processor may communicate the determined condition to one or more devices across a network

In some embodiments, the condition may be a fault within the rail environment. The condition may include an actual failure (e.g., an existing failure or a failure that has occurred), a potential failure, or signature deviating from the expected signature over a threshold. The potential failure may include one or more of a recommendation of maintenance or predicted failure. In some embodiments, the fault within the rail environment may include a failure of a bearing of the wheelset, a failure of a wheel of the wheelset, a failure of a rail or weld of a track in contact with the train, or a misaligned geometry of a track in contact with the train.

In some embodiments, the data points of the wheelset may include one or more of: an acoustic signal (e.g., sound signal level), a vibration signal (e.g., acceleration or vibration level), a rotation (e.g., orientation, rotational signal, or rotational rate) of an axle of the wheelset, a temperature, an atmospheric pressure, a time, a location (e.g., geographic location) of the wheelset; and a velocity (or speed) of the wheelset. In some embodiments, the wheelset environment may include a history of one or more of the data points. A global positioning system may capture the time, location, or velocity. In some embodiments, the processor may be further configured to correlate the expected signature to location data.

In some embodiments, the processor may be further configured to diagnose faults within the wheelset environment associated with sensors. The measuring may be performed the sensors. The diagnosing may be performed based upon loss of at least one message or signal sent to or received from an external source.

In some embodiments, the system may include an energy harvesting module configured to harvest power based upon a rotation of an axle of the wheelset. The harvested power may enable the measuring, the comparing, or the determining. In some embodiments, the system may harvest power based upon a self-contained power generator enclosed within a housing (e.g., bearing end cap) of a bearing of the wheelset. In some embodiments, the system may harvest power based upon a power generator comprised of a rotor (e.g., magnets) and a stator (e.g., coils). The rotor and stator may be included in an outer housing of a bearing of the wheelset.

In an embodiment, a non-transitory computer-readable medium can be configured to store instructions for determining a condition within a rail environment. The instructions, when loaded and executed by a processor, may cause the processor to measure data points of a wheelset environment. The wheelset environment may be local to a wheelset of a train. The processor may compare a signature of the data points of the wheelset environment to an expected signature. The expected signature may represent a baseline of normal operations within the rail environment. The processor may determine the condition within the rail environment responsive to the comparison of the signature to the expected signature. The processor may communicate the determined condition to one or more devices across a network.

In some embodiments, the condition may be a fault within the rail environment. The condition may include an actual failure (e.g., an existing failure or a failure that has occurred), a potential failure, or signature deviating from the expected signature over a threshold. The potential failure may include a recommendation of maintenance or predicted failure. The signature may deviate from the expected signature over a threshold.

In some embodiments, the fault within the rail environment may include a failure of a bearing of the wheelset, a failure of a wheel of the wheelset, a failure of a rail or weld of a track in contact with the train, a misaligned geometry of a track in contact with the train, a derailment of a wheelset, or a failure of an axle of the wheelset.

In some embodiments, the data points of the wheelset may include one or more of: an acoustic signal (e.g., sound signal level), a vibration signal (e.g., acceleration or vibration level), a rotation (e.g., orientation, rotational signal, or rotational rate) of an axle of the wheelset, a temperature, an atmospheric pressure, a time, a location (e.g., geographic location) of the wheelset; and a velocity (or speed) of the wheelset. In some embodiments, the wheelset environment may include a history of one or more of the data points.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is high level block diagram illustrating an example embodiment of a system employed by the present disclosure.

FIG. 2 is a graph illustrating causes and frequency of rail accidents.

FIG. 3A is a picture illustrating a rail mounted track monitor.

FIG. 3B is a picture illustrating a track load monitor.

FIG. 3C is a picture illustrating a mobile track inspection vehicle.

FIG. 3D is a picture illustrating a change in rail curvature.

FIG. 3E is a map illustrating a portion of existing train tracks in North America.

FIG. 4 is a diagram illustrating an example embodiment of a rail car truck and corresponding wheelset.

FIG. 5 is a diagram illustrating of an example embodiment of a wheelset bearing.

FIG. 6A is a block diagram illustrating an example embodiment of a wheelset sensor employed by embodiments of the present disclosure.

FIGS. 6B-F illustrate methods of failure detection according to embodiments of the present disclosure.

FIG. 7 is a diagram illustrating a wheelset sensor and its various subsystems employed by embodiments of the present disclosure.

FIG. 8 is a flow diagram illustrating an example embodiment of the present disclosure.

FIG. 9A is a diagram illustrating an example embodiment of power harvesting.

FIG. 9B is a diagram illustrating another example embodiment of power harvesting.

FIG. 10 illustrates a computer network or similar digital processing environment in which embodiments of the present disclosure may be implemented.

FIG. 11 is a diagram of an example internal structure of a computer (e.g., client processor/device or server computers) in the computer system of FIG. 10, according to some embodiments.

### DETAILED DESCRIPTION

A description of example embodiments of the disclosure follows.

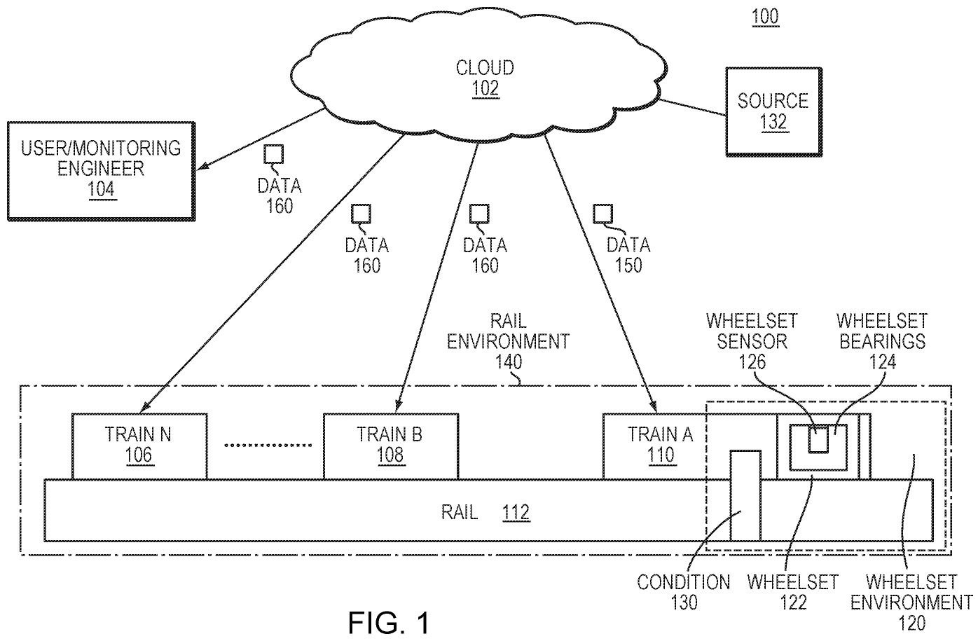

FIG. 1 is high level block diagram illustrating an example embodiment of a system 100 employed by the present disclosure.

Breaks in railroad tracks and failures of railroad bearings may be difficult to predict or detect, and may result in failures that can lead to loss of equipment, life, or both on a large scale. For example, a derailed train in Canada that was transporting crude oil caused several deaths and hundreds of millions of dollars in damages. Although rail safety overall is high, the size and cargo of trains increase the scale of damage of accidents. Current methods of inspecting tracks and cars rely on infrequent, human driven, measurements of conditions of the track and the wheelsets of the rolling stock cars. More reliable approaches are needed to prevent such catastrophic accidents.

A rail environment 140 includes a rail 112 (e.g., train track), and at least one train, which can include train A 110, train B 108, and train N 106. In an embodiment, a wheelset sensor 126 is a sensor suite that can detect conditions and faults within the rail environment 140, including conditions and faults of the rail 112 itself, and conditions of a train 110 connected to the wheelset sensor 126.

According to some embodiments, the one or more wheelset bearings 124 can be installed on an existing wheelset 122. The bearings 124 may be changed multiple times over the life of a typical wheelset.

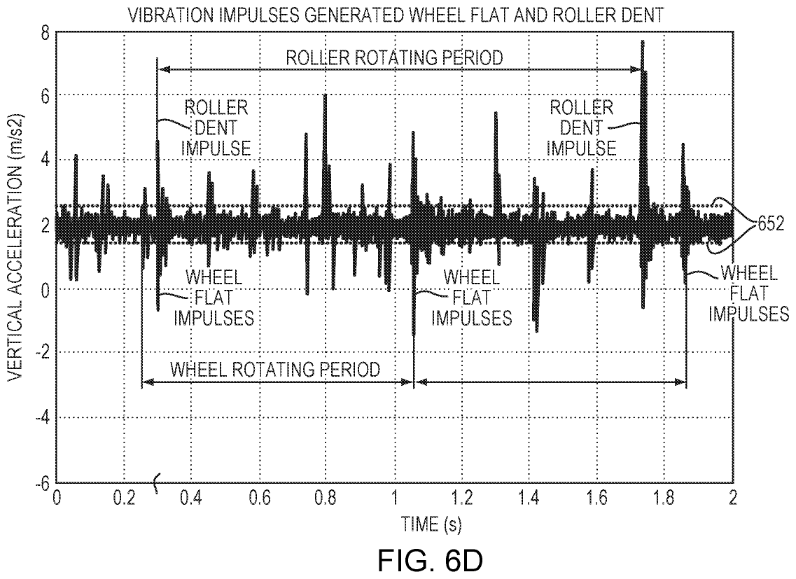

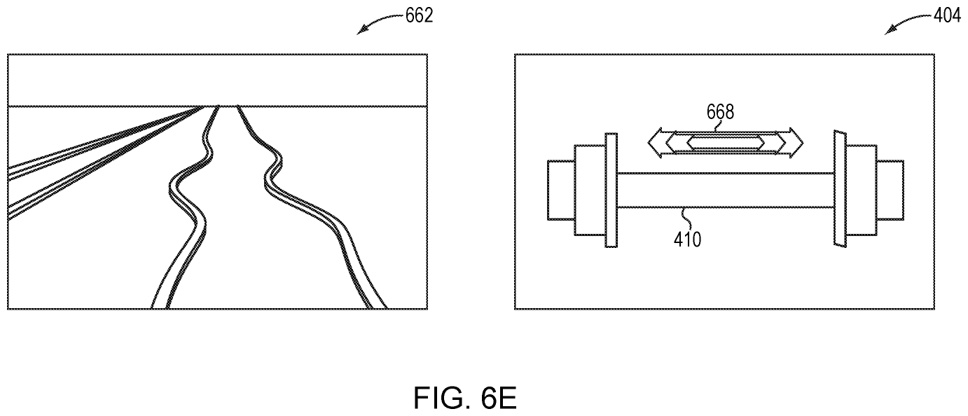

As further illustrated in FIG. 1, in some embodiments, the wheelset sensor 126 can be installed to standard rail car roller bearings to provide the one or more wheelset bearings 124 (also referred to as “bearings” herein). The modification may include adding measurement and communications electronics directly into the wheelset bearing 124 or on the outside of the wheelset bearing 124. The sensors 126 (which may also be referred to as “embedded sensors” herein) may include accelerometers, gyroscopes, microphones, or GPS (shown later in FIG. 6A to follow) and may collect high frequency vibration and acoustic data whenever the train 110 is rolling. In addition, the wheelset sensor 126 can be constructed with new wheelset bearings 124 customized for the sensors and power requirements of the wheelset sensor 126. Data 150 collected by the wheelset sensor 126 may be uplinked/uploaded (e.g., via a cellular data modem) via the electronics of the wheelset bearings 124 to a cloud service 102. The cloud service 102 is configured to process one or more signals included in the data 150, looking for signs of failure of the rail 112, the train 110, or the wheelset bearings 124. As part of the processing, the cloud 102 may send a the data 160 that indicates a condition of the rail 112 or trains 106, 108, or 110 to a user or monitoring engineer 104 or to one or more other trains (trains B 108 through N 106, respectively). A person of ordinary skill in the art can recognize that while FIG. 1 illustrates train A 110, train B 108, and train N 106, that any number of trains may employ embodiments of the wheelset bearings 124 and perform embodiments of the present disclosure. Such trains described herein may include revenue service trains (e.g., trains that carry passengers or revenue-earning freight or goods).

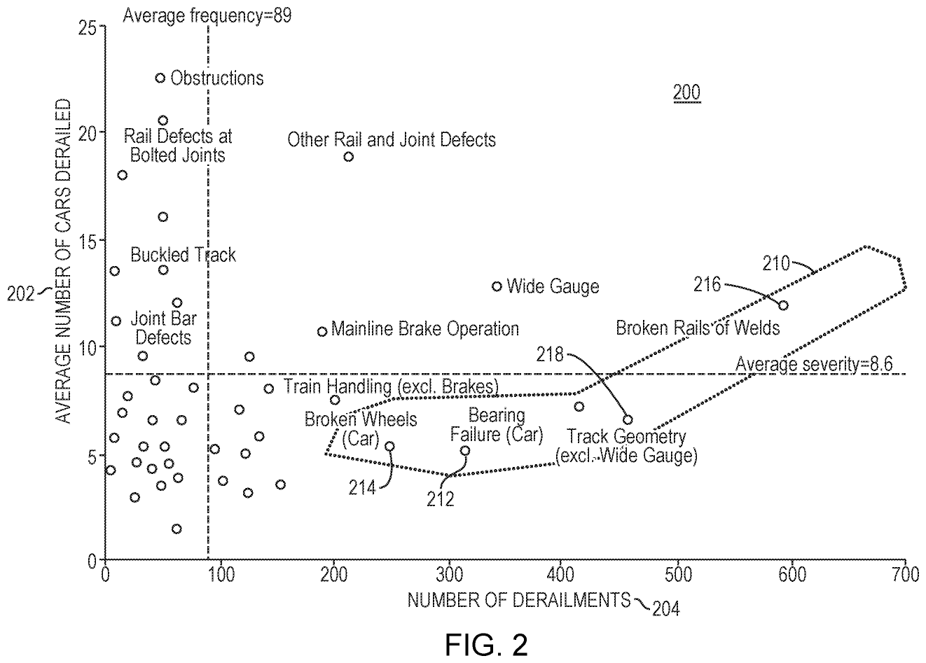

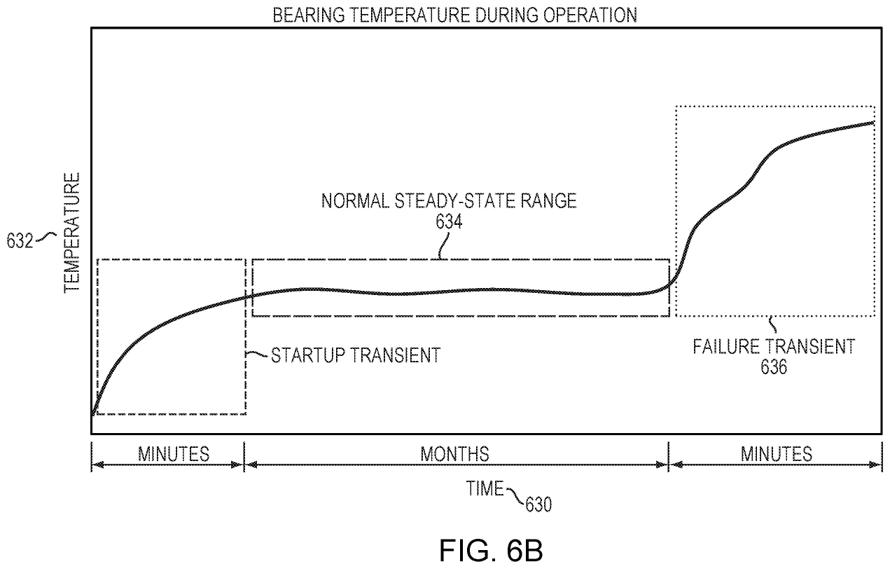

Examples of a condition 130 within the rail environment 140 include a fault that includes a failure of a bearing of the wheelset, a failure of a wheel of the wheelset, a failure of a rail or weld of a track in contact with the train, a misaligned geometry of the track in contact with the train, a derailment of a wheelset, or a failure of an axle of the wheelset, but can also include other conditions, including conditions illustrated in reference to FIG. 2. In reference to FIG. 1, the wheelset sensor 126 measures data points within (or on) a wheelset environment 120. The wheelset environment 120 may be local to a wheelset 122 of a train 110. Wheelsets are described in further detail in relation to FIG. 4.

In reference to FIG. 1, the wheelset sensor 126 compares a signature of the data points of the wheelset environment 120 to an expected signature. The expected signature represents a baseline of normal operations within a rail environment 140. The wheelset sensor 126 determines the condition 130 within the rail environment 140 responsive to the comparison of the signature to the expected signature. The wheelset sensor 126 may communicate the determined condition 130 to one or more devices across a network 102.

In some embodiments, the condition 130 may be a fault within the rail environment 140. The condition 130 may include an actual failure (e.g., an existing failure or a failure that has occurred), a potential failure, or the signature deviating from the expected signature over a threshold. The potential failure may include one or more of a recommendation of maintenance or predicted failure.

The wheelset sensor 126 collects various data points of the wheelset environment 120 that can include an acoustic signal (e.g., sound signal level), a vibration signal (e.g., acceleration or vibration level), a rotation (e.g., orientation, rotational signal, or rotational rate) of an axle of the wheelset 122, a temperature, an atmospheric pressure, a time, a location (e.g., geographic location) of the wheelset; and a velocity (or speed) of the wheelset. In some embodiments, the wheelset environment may include a history of one or more of the data points.

In some embodiments, the electronics of the wheelset bearings 124 may correlate the expected signature to location data. For example, rail 112 is often broken as a train rolls over the rail itself. While often the train that rolls over the rail 112 as the rail breaks does not derail, the next train is placed in danger if it has no warning about the broken rail. However, if the rail 112 breaks when train A 106 rolls over it, the wheelset bearing sensor 126 can detect the rail being broken by an acoustic signature or vibratory signature, for example. In one example, the signature can be a sudden spike in amplitude detected at an acoustic sensor. This acoustic spike in amplitude can exceed an expected signature, and be indicative of a broken rail. However, the expected signature can correlate to location data in areas where the rail is expected to be noisy (e.g., a sharp turn of the rail, a facility nearby that regularly creates loud and sudden noises), which can eliminate false positives detected by the system.

In some embodiments, the electronics of the wheelset bearings 124 may diagnose one or more faults within the wheelset environment 120 associated with one or more sensors 126. The electronics of the wheelset bearings 124 may perform the measuring by the one or more sensors 126. The electronics of the wheelset bearings 124 may perform the diagnosing based upon loss of at least one message or signal sent to or received from an external source 132 (which may be accessible via or present in the cloud 102).

The wheelset sensor 126 sends its collected data, or a respective analysis thereof, to the cloud 102. A server connected to the cloud can process the data from the wheelset sensor 126, and if a fault or predicted fault is detected, begin corrective action. For example, in the case of a predicted failure, warnings can be sent to all trains (e.g., train B 108 and train N 106) on the rail 112, and a maintenance request can be sent to a user or monitoring engineer 104. Then, inspection or maintenance can be performed at the site of the condition 130 to prevent an actual failure from occurring.

In the event of an actual failure to the rail 112, the server connected to the cloud can send warning message(s) to train B 108 and train N 106 that are using the same rail 112, including instructions to stop the train or divert the train's path before reaching the condition 130. In the case of an highly-autonomous train, train B 108 and train N 106 can stop or divert the train's path automatically, and in the case of a manually-operated train, the operator can respond accordingly. In addition, the server connected to the cloud can send a message to the monitoring engineer 104 to fix the actual failure. For example, in the event of a condition 130 of a broken rail 112 that occurred as train A 110 traveled over the condition 130, the wheelset sensors of train A 110 send data/messages to the server in the cloud 102, which relays warnings to train B 108 and train N 110, as well as the user/maintenance engineer 104. Train B 108 and Train N 110 avoid the damaged rail 112 by stopping or diverting their routes, and the user/maintenance engineer 104 is dispatched to the location of the condition 130.

In the event of a condition 130 detected at the train A 110, the train can respond by stopping, or getting inspection at a next station or designated point, or continue to its destination if the condition 130 is not likely to impact the outcome of the current trip. For example, a wheelset sensor 126 of the train A 110 can detect that its wheelset bearings 124 temperature exceeds a threshold, indicating a problem with the bearing. The train can, in response, slow down or stop and request inspection, or execute other corrective action.

An additional problem overcome by embodiments of the wheelset sensor 126 is replacing non-chargeable batteries by employing an energy harvesting power source. Current rail cars may not be used for months or years, and batteries used by those cars can be drained of charge power, which causes manual replacement of those batteries. By contrast with these existing approaches (e.g. replaceable batteries), an energy harvesting wheelset sensor 126 solves this problem.

In some embodiments, the electronics of the wheelset bearings 124 may harvest power based upon a rotation of an axle of the wheelset 122. The harvested power may enable the measuring, the comparing, the communicating, and the determining.

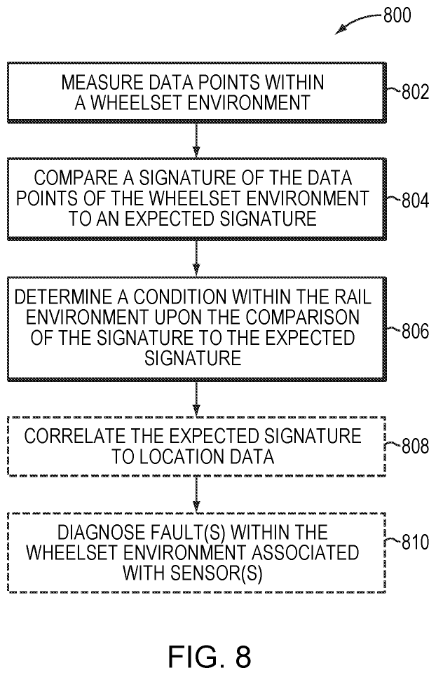

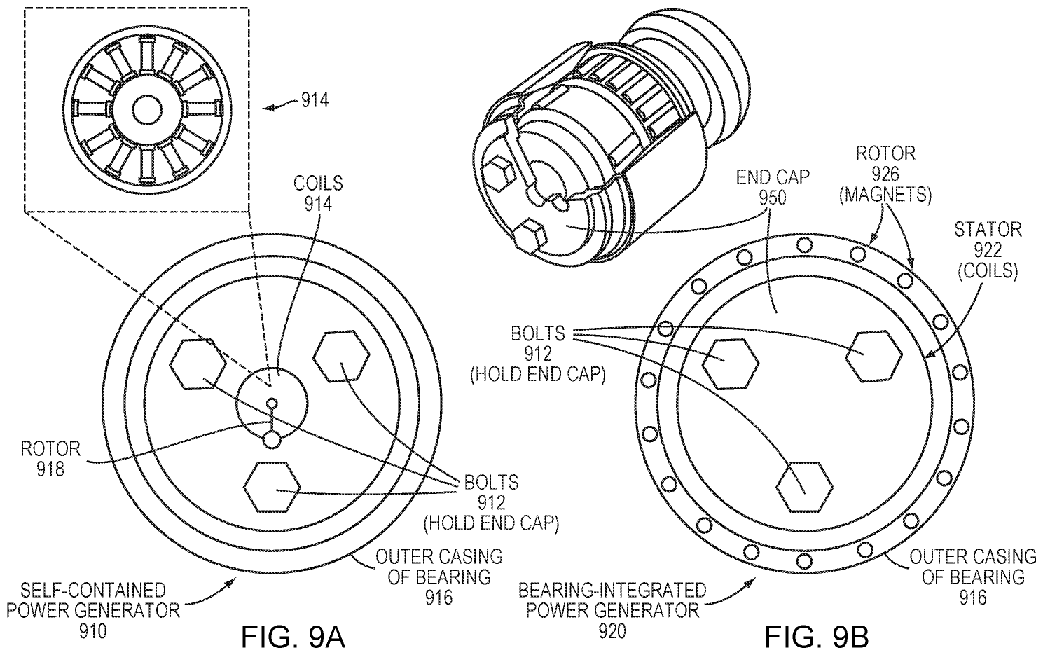

In some embodiments, the electronics of the wheelset bearings 124 may harvest power based upon a self-contained power generator (described below in relation to FIG. 9A) enclosed within a housing (e.g., bearing end cap) of one or more bearings 124 of the wheelset 122. In some embodiments, the method may harvest power based upon a power generator (described below in relation to FIG. 9B) comprised of a rotor (e.g., magnets) and a stator (e.g., coils). The rotor and stator may be included in an outer housing of one or more bearings 124 of the wheelset 122.

FIG. 2 is a graph 200 illustrating causes and frequency of rail accidents. The graph 200 illustrates multiple points that each represent a cause of derailment, where the horizontal axis 200 of the graph indicates a number of derailments 204 and the vertical axis indicates an average number of cars derailed 200 for each given point. The graph 200 illustrates that the most frequent causes of derailments are (1) a fault 210 within the rail environment that may include a failure of a bearing of the wheelset 212, (2) a failure of a wheel of the wheelset 214, (3) a failure of a rail or weld of a track in contact with the train 216, (4) a misaligned geometry 218 of the track in contact with the train, (5) a derailment of a wheelset, or (6) a failure of an axle of the wheelset.

As illustrated in FIG. 2 other causes of derailment may include other rail and joint defects, rail defects at bolted joints, joint bar defects, buckled track, obstructions, wide gauge, mainline brake operation, or train handling (excluding brakes). In some embodiments, the sensors 126 (of FIG. 1) may measure many causes of derailment 210 of FIG. 2 continuously over time, as many causes of derailment 210 may have detectable traits that can predict future failure, indicate a current failure, or other condition.

A variety of track or car inspection methods exist.

For bearing failures, there are existing trackside devices that may be known as “hotbox” detectors that may read the surface temperature of each bearing as a train rolls by. However, unlike some embodiments, such existing “hotbox” detectors may be limited in their placement or location. As such, and as bearings may fail at various times, embodiments are advantageous compared with the existing “hotbox” detectors.

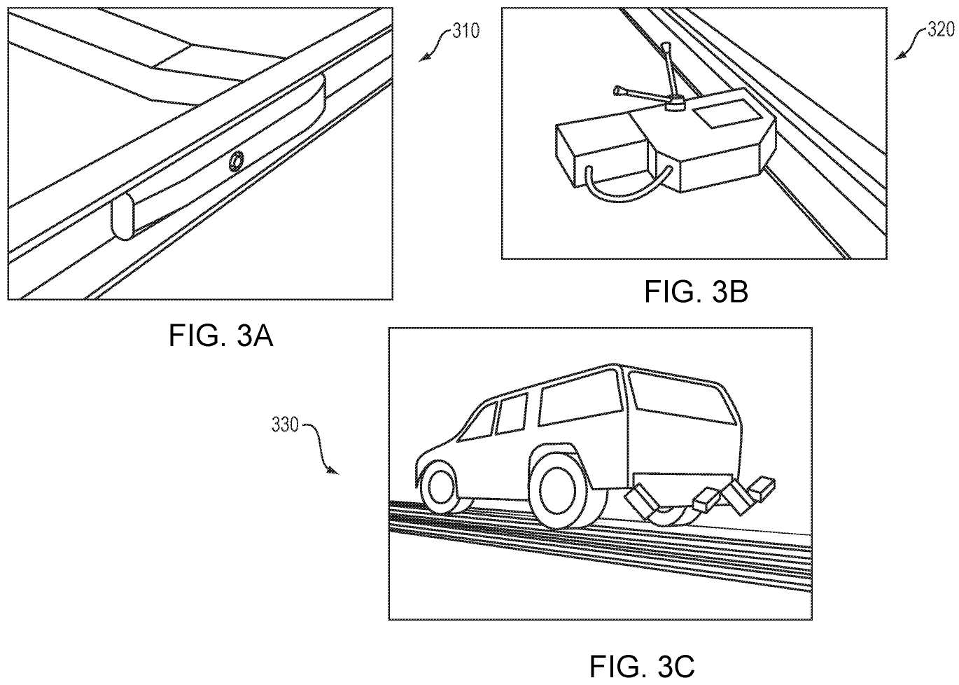

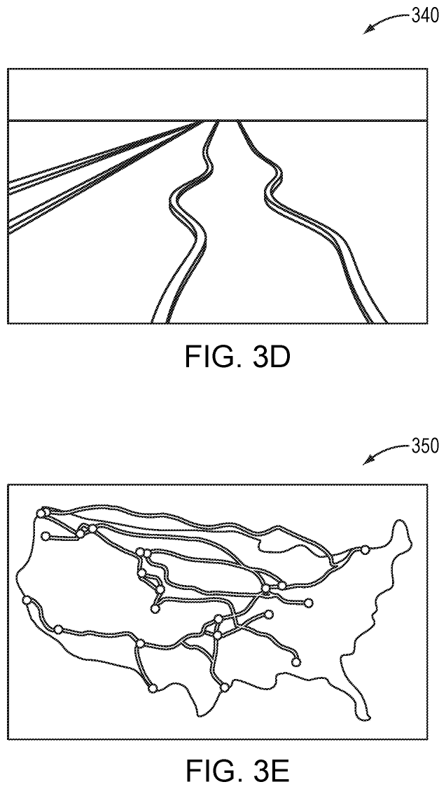

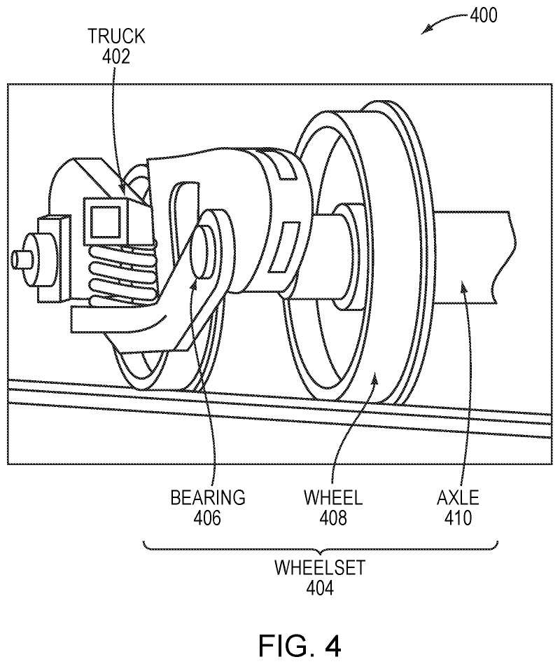

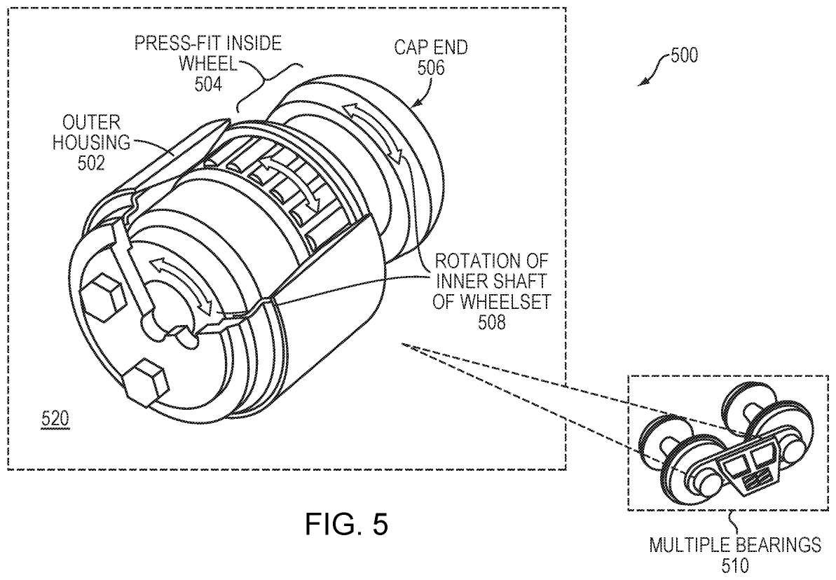

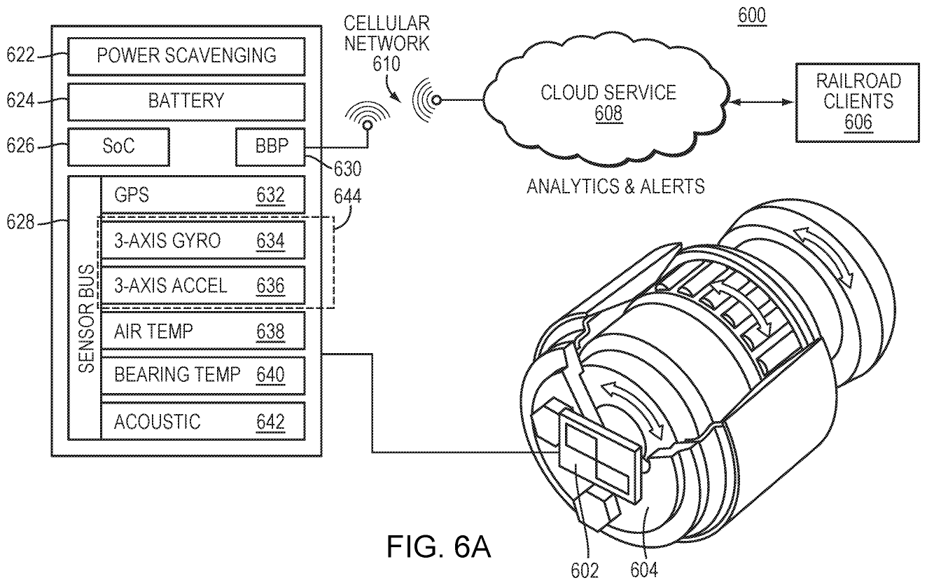

FIGS. 3A-C illustrate other various failure detection techniques that do not measure surface temperature.

FIG. 3A is a picture illustrating a rail mounted track monitor 310. In FIG. 3A, the rail mounted track monitor 310 provides guided wave ultrasonic break detection, but is limited to locations with high installation cost. Such guided wave ultrasonic break detection measures stress in a rail to predict failures. Ultrasonic break detection measures strain in metal using electrical current and can measure strain in steel by using fine deflections.

FIG. 3B is a picture illustrating a track load monitor 320. In FIG. 3B, the track load monitor 320 is designed to measure and log the stress in the rail. The track load monitor 320 may include an ultrasonic inspection device that generates an image of interior cavity of a rail to detect cracks inside of metal of the rail.

FIG. 3C is a picture illustrating a mobile track inspection vehicle 330. Although mobile track inspection utilizes a vehicle 330 to perform a visual inspection, mobile track inspection may be limited by availability and may interrupt train service. Such mobile track inspection may track geometry of the track or rail car using lasers to measure a profile to measure spacing. As such, mobile track inspection may measure the dimensions of the track to detect bends or an incorrect width of the track. However, mobile track inspection is not practical because, given the large number of miles of train track, and mobile track inspection may occur infrequently.

The existing track or car inspection methods illustrated in FIGS. 3A-C do not solve the problem of track inspection because they only cover limited segments of the track and are expensive and impractical to deploy or maintain. Therefore, for the existing approaches of FIGS. 3A-C (and their limitations) the condition of many miles of track and many of the rolling stock is unknown until an accident occurs, which is a problem solved by embodiments herein.

FIG. 3D is a picture illustrating a change in rail curvature 340. As illustrated in FIG. 3D, a change in rail curvature 340 can be a curve that is difficult for a train to navigate. Some other problems encountered in rail networks include broken joints, cracks, and other broken rail conditions. Embodiments of the present disclosure may solve such problems by monitoring bearing or wheel conditions including detecting bearing over temperature determining rotation speeds, detecting wheel flats, monitoring braking, or detecting slippage, and responding by sending contemporaneous alerts.

FIG. 3E is a map illustrating a portion of existing train tracks in North America. As illustrated by the map of FIG. 3E, existing major train tracks in North America span thousands of miles. Such a length of track is prohibitive for installing monitoring along the track itself. Embodiments of the present disclosure solve this problem by allowing the trains themselves that traverse the thousands of miles of tracks to inspect the track as they travel. In addition, location history of a given train within such an example map may be difficult to record (or maintain). However, embodiments may easily track (or record or maintain) location history. In addition to tracking location history, embodiments may track a distance travelled, a grade travelled, or a curvature travelled.

FIG. 4 is a diagram 400 illustrating an example embodiment of a rail car truck 402 and corresponding wheelset 404. The truck includes a wheelset 404, which includes a bearing 406, wheel 408, and axle 410. Trucks 402 sit on the bearings 406 of each wheelset 404. In some embodiments, a wheelset 404 may weigh from 1000 pounds (lbs) to 2500 pounds (lbs). Although wheelsets 404 are typically close to 1000 pounds (lbs), and may be over 2000 (lbs), embodiments herein do not limit the weight of wheelsets 404. In some embodiments, the wheelset 404 may applied to one or more freight trains or any other type of train known to one skilled in the art.

A wheelset may travel one million miles or more between service. Wheelsets 404 may be serviced independently of trucks 402 or cars of the trucks 402. In some embodiments, a train may include approximately 50-60 cars with 2 trucks per car. In some embodiments, a train may include up to 180 cars. However, embodiments are no so limited and any number of cars or trucks per car may be employed.

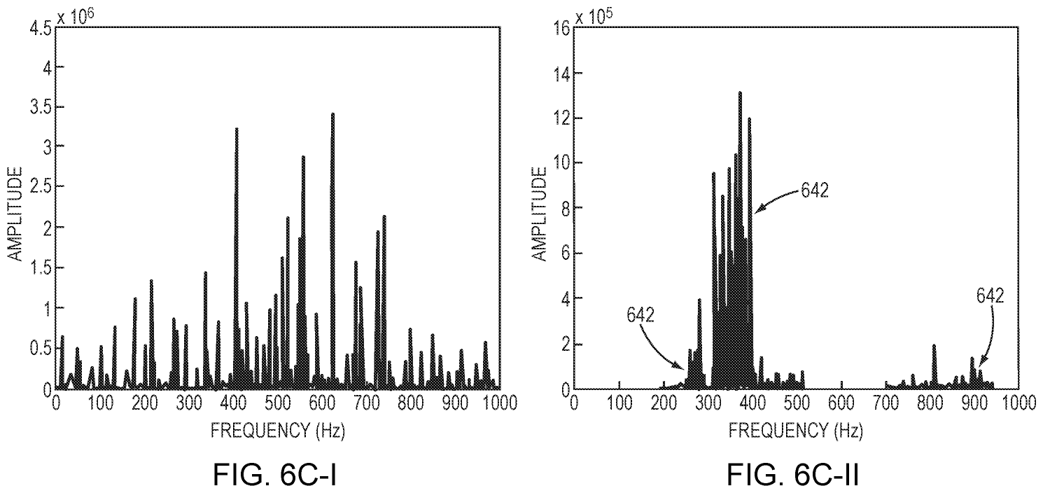

FIG. 5 is a diagram 500 illustrating of an example embodiment of a wheelset bearing 520. The bearing 520 can be one of a set of multiple bearings 510 of a rail truck. The bearing includes an outer housing 502. In some embodiments, outer housing 502 is 6-12 inches in diameter. In some embodiments, the some embodiments, the diameter of the outer housing 502 may depend on a weight rating of the bearing 520 and the axle.

The outer housing does not rotate relative to a press-fit inside wheel 504 of the bearing 502. The bearing 502 further includes a cap end 506 proximal to the press-fit inside wheel 504. As illustrated by FIG. 5 embodiments may include a plurality 510 of the bearings 520. In one example embodiment, the plurality 510 of bearings can include 4 to 6 bearings.

FIG. 6A is a block diagram illustrating an example embodiment of a wheelset sensor employed by embodiments of the present disclosure. As illustrated in FIG. 6, an advantage of some embodiments is the concept of placing measurement sensors or computing 602 within a bearing 604. Low cost small cellular electronics (e.g., radios, transmitters, receivers, etc.) enable sensors or electronics 602 to easily fit in the confines of the end-cap of the bearing 604.

As illustrated in FIG. 6, embodiments of the wheelset sensor 600 may be included as part of a wheelset bearing 604 (or “bearing” herein). The bearing 604 may include measurement or communications electronics via an electronics unit 602. In some embodiments, existing deployed bearings are modified to include the electronics 602. In other embodiments, the bearings 604 are newly manufactured with the electronics 602.

The electronics unit 602 may be powered by a battery 624 or by a power scavenging module 622 that may scavenge (harvest) power based upon movement of a wheel connected to the bearing 604, or by both. The electronics unit 602 may include a first processing unit 626 that may include a system on a chip, a central processing unit, or any other processor known to one skilled in the art. The first processing unit 626 may perform cell-phone class processing. The first processing unit 626 may be coupled to a sensor bus 628 that transmits information to and from various sensors, as described below.

The sensor bus 628 connects to sensors 630, 632, 634, 636, 638, 640, and 642. These sensors 630, 632, 634, 636, 638, 640, and 642 may include: (i) an accelerometer 636 which may measure vibration or acceleration or perform other functions known to one skilled in the art; (ii) a gyroscope 634 which may measure orientation, or perform other functions known to one skilled in the art; (iii) an air temperature sensor 638 which may measure temperature of air surrounding the bearing or perform other functions known to one skilled in the art; (iv) a bearing temperature sensor 640 which may measure temperature of the bearing 604 including measuring the inner or outer temperature of the bearing 604, or perform other functions known to one skilled in the art; (v) an acoustic sensor 642 which includes but is not limited to being a microphones which may measure sound or vibration; and (vi) a global positioning system (GPS's) 632 which may track location history, time, a distance travelled by the train, and may provide an output which may be post-processed to provide a grade or curvature traveled by the train.

In an embodiment, the (i) accelerometer 636 may measures the rate of change of velocity of an object, typically in three orthogonal directions such as X (e.g., horizontal), Y (e.g., vertical), and Z (e.g., depth) axes of a Cartesian coordinate frame, units being in square length (per second). Accelerometers 636 may be used to measure the linear motion of objects. Accelerometers 636 may measure high frequency and amplitude vibrations, such as the high frequency and amplitude vibrations of a wheelset. As such, accelerometers 636 may provide information regarding how much a wheel is vibrating in one or more of three orthogonal directions.

In an embodiment, the (ii) gyroscope 634 may measure a rate of turning of an object around the X (e.g., horizontal), Y (e.g., vertical), and Z (e.g., depth) axes, units being in degrees or radians per second. Gyroscopes, also known as gyros, can determine object is pointed (e.g., oriented) with respect to a frame of reference. In some embodiments, a gyroscope 634 axis may be rotational axis of the wheelset, thereby providing a measurement of the wheel turning speed.

In an embodiment, the (iii) air temperature sensor 638 measures ambient outdoor temperature. The tip of the air temperature sensor is surrounded by only air, which in turn then may be used to measure ambient outdoor temperature. In some embodiments, very hot days shift up the thresholds for bearing over-temperature, acoustic parameters change on hot versus cold days, or accelerometers and gyros have temperature varying error properties. The air temperature itself may also vary parameters of fault detection algorithms.

In an embodiment, the (iv) a bearing temperature sensor 640. Much like the air temperature, the bearing temperature itself may also vary parameters of fault detection algorithms. Hot versus cold bearings may change the sounds emitted by the bearing.

In an embodiment, the (v) an acoustic sensor 642 may include a microphone that converts sound waves in the air into electrical signals. A processor 626 may then process these converted electrical signals to determine the frequency content (e.g., spectra) and power (e.g., loudness) in each frequency of the electrical signals. One or more sounds, like a cracking rail, may be detectable before or after a wheel rolls over that crack, may be able to use sounds to diagnose issues with air brakes as well.

In an embodiment, the (vi) a global positioning system (GPS's) 632 may report a position of the car or the distance travelled by the car. In some embodiments, GPS 632 may comprise a timing source. GPS 632 may collect one or more sensor measurements and synchronize these one or more collected measurements to perform certain one or more types of processing. GPS 632 may include a high accuracy clock source that is easy to obtain over-the-air.

According to some embodiments, one or more of the sensors (630, 632, 634, 636, 638, 640, and 642, collectively) may collect high frequency vibration or acoustic data (or signals) whenever the train is rolling. According to some embodiments, the accelerometers 636 or gyroscopes 634 may collectively (e.g., combine to) form an inertial measurement unit 644 which may collect the high frequency vibration or acoustic data or signals. According to some embodiments, the acoustic sensors 642, which may include microphones, may measure acoustic, sound, or vibration signals.

As illustrated in the wheelset sensor 600 of FIG. 6, a novel aspect (or advantage) of some embodiments is that direct measurement of vibrations or acoustics at the wheel may allow predictive analytics for a wide variety of conditions.

A first processing unit 626 may transmit the data (or signals) including information or alerts received from one or more of the embedded sensors (collectively 630, 632, 634, 636, 638, 640, and 642 of FIG. 6) or may transmit the corresponding data or signals including information or alerts to a second processing unit 630. The second processing unit 630 may included in, separate from, or work in conjunction with the first processing unit 626. The second processing unit 630 may include a baseband processor (including but not limited to a cell-phone class baseband processor), network management hardware, or a cellular data modem.

The second processor unit 630 may forward the data, signals, information, or alerts received from the first processing unit 626 to a cloud service 608 via a cellular network 610. In other words, the second processing unit 630 may uplink data (via a cellular data modem 610 or other device known to one skilled in the art that may be included in, work in conjunction with, or be separate from the second processing unit 630) to a cloud service 608 that may process the data (which may include signals, alerts, or other information) looking for signs of failure of the track or bearing 604. As part of the processing, the cloud 608 may send a portion or all of the data to one or more railroad clients 606 which may include a user, a monitoring engineer, or one or more other trains.

According to some embodiments, as illustrated in FIG. 6, the bearing 604 and corresponding electronics 602 may perform one or more measurements, one or more comparisons, determine one or more conditions, correlate one or more expected signatures, or diagnose one or more faults by the electronics 602 (including the sensors 630, 632, 634, 636, 638, 640, or 642, the sensor bus 628, the first processor 626, the second processor 630, the battery 624, the power scavenging unit 622, or any other electronics, software including embedded software, or hardware known to one skilled in the art).

As such, the wheelset sensor 600 may measure data points within (or on) a wheelset environment via electronics 602. As such, next, the wheelset sensor 600 may compare a signature of the data points of the wheelset environment to an expected signature via electronics 602. Next, the wheelset sensor 600 may determine a condition within the rail environment responsive to the comparison of the signature to the expected signature via electronics 602. The wheelset sensor 600 may communicate the determined condition to one or more devices across a network (e.g., cloud service 608). In an alternative embodiment, however, the wheelset sensor 600 can upload collected data to the cloud service 608, which determines any conditions or faults remotely and sends corresponding notifications of the same.

Based upon the detected condition, the wheelset sensor 600 may notify railroad clients 606 (e.g., other trains in the network) of the determined condition (e.g., so that other trains may stop service to avoid collision with the train) by transmitting a notification to these trains via the second processor 630 through the cellular network 610 or over a cloud service 608. In another embodiment, the cloud service 608, having analyzed the data received from the wheelset sensor 600, can send notifications to other railroad clients 606 of the determined condition.

In addition, the wheelset sensor 600 may correlate the expected signature to location data via electronics 602. Further, the method may diagnose fault(s) within the wheelset environment based on data detected by one or more of the sensors 630, 632, 634, 636, 638, 640, or 642 via electronics 602.

In some embodiments, the condition may be a fault within the rail environment. The condition may include an actual failure (e.g., an existing failure or a failure that has occurred), a potential failure, or the signature deviating from the expected signature over a threshold. The potential failure may include one or more of a recommendation of maintenance or predicted failure.

Referring back to FIG. 6, in some embodiments, the data points of the wheelset environment that are detected via one or more of the sensors 630, 632, 634, 636, 638, 640, and 642, or the electronics 602, as described above, may include at least an an acoustic signal (e.g., sound signal level), a vibration signal (e.g., acceleration or vibration level), a rotation (e.g., orientation, rotational signal, or rotational rate) of an axle of the wheelset, a temperature, an atmospheric pressure, a time, a location (e.g., geographic location) of the wheelset; and a velocity (or speed) of the wheelset. In some embodiments, the wheelset environment may include a history of one or more of the data points.

In some embodiments, the wheelset sensor 600 may correlate the expected signature to location data via the electronics unit 602 via the first processing unit 626 or the second processing unit 630. In some embodiments, the wheelset sensor 600 may diagnose one or more faults within the wheelset environment associated with one or more sensors 630, 632, 634, 636, 638, 640, or 642. The method may perform the measuring by the one or more sensors 630, 632, 634, 636, 638, 640, or 642. The wheelset sensor 600 may perform the diagnosing based upon loss of at least one message or signal sent to or received via the cellular network 610 from an external source including but not limited to sources associated with or within the cloud 608.

In some embodiments, the wheelset sensor 600 may harvest power via a power harvesting module 622 based upon a rotation of an axle of the wheelset. The harvested power may enable one or more of the measuring, the comparing, or the determining. In some embodiments, the wheelset sensor 600 may harvest power based upon a self-contained power generator enclosed within a housing (e.g., bearing end cap) of a bearing 604 of the wheelset. In some embodiments, the wheelset sensor 600 may harvest power based upon a power generator comprised of a rotor (e.g., magnets) and a stator (e.g., coils). The rotor and stator may be included in an outer housing of a bearing 604 of the wheelset.

For each problem listed above, the one or more sensors 630, 632, 634, 636, 638, 640, and 642 may measure data points within (or on) a wheelset environment. The data points may include an acoustic signal (e.g., sound signal level), a vibration signal (e.g., acceleration or vibration level), a rotation (e.g., orientation, rotational signal, or rotational rate) of an axle of the wheelset, a temperature, an atmospheric pressure, a time, a location (e.g., geographic location) of the wheelset; and a velocity (or speed) of the wheelset. In some embodiments, the wheelset environment may include a history of one or more of the data points.

The first processor 626 may compare a signature of the data points of the wheelset environment to an expected signature. Next, the first processor 626 may determine a condition within the rail environment responsive to the comparison of the signature to the expected signature. Based upon the detected condition, the first processor 626 may notify other trains in the network of the determined condition (e.g., so that other trains may stop service to avoid collision with the train) by transmitting a notification to these trains via the second processor 630 through the cellular network 610 or over a cloud service 608. The second processor 630 may communicate the determined condition to one or more devices (of network clients 606) across a network (e.g., cloud service 608). To detect each condition or fault listed above, various sensors are used as described in further detail below.

Embodiments of the wheelset bearing sensor solve each of these most frequent causes of derailments, as described in relation to FIG. 2. As such, in some embodiments, the fault within the rail environment may include at least (1) a failure of a bearing of the wheelset, (2) a failure of a wheel of the wheelset, (3) a failure of a rail or weld of a track in contact with the train, (4) a misaligned geometry of the track in contact with the train, (5) a derailment of a wheelset, or (6) a failure of an axle of the wheelset. In some embodiments, vibrations, the acoustics, temperature fluctuations, or other means known to one skilled in the art may be failure predictors using the wheelset bearing sensor.

In an embodiment, to (1) detect a failure of a bearing of the wheelset, the wheelset sensor can monitor bearing temperature during motion (see FIG. 6B) or monitor bearing vibration (see FIG. 6C).

In an embodiment, as illustrated in FIG. 6B, once a bearing begins to fail catastrophically, it starts to heat up—rapidly. These bearings are carrying tons of load, and the friction is massive. The bearing temperature sensor may register a rapid rise in temperature (relative to the nominal) and can trigger the alert for the bearing failure. As illustrated in FIG. 6B, a failure of a bearing of the wheelset may be detected by monitoring bearing temperature 632 during motion, and when the bearing breaks a failure transient occurs, resulting in a hot temperature 636 as compared with the normal steady-state range 634. Some embodiments measure data over long periods of time continuously and have predictive capability. As illustrated in FIG. 6B, timescales 630 may be months or years.

In an embodiment, as illustrated in FIG. 6C (collectively FIGS. 6C-I and 6C-II), a failure of a bearing of the wheelset may be detected by monitoring bearing vibration. FIG. 6C-I illustrates vibration spectra (amplitude vs. frequency) of an undamaged rail wheelset bearing. FIG. 6C-II illustrates vibration spectrum (amplitude vs. frequency) of a faulty rail wheelset bearing. As illustrated in FIG. 6C-II, different types of faults can be identified based on the spectra 642 of the vibration spectrum.

In an embodiment, to (2) detect a failure of a wheel of the wheelset, the wheelset bearing sensor measures vertical wheel motion (acceleration shown) as shown in FIG. 6D. Similarly, to (3) detect a failure (e.g., break) of a rail or weld of a track in contact with the train the wheelset bearing sensor measures vertical wheel motion (acceleration shown) as shown in FIG. 6D.

In an embodiment, FIG. 6D illustrates the wheelset bearing sensor measuring the vibration and acceleration of the wheeleset itself over time. As such, the wheelset bearing sensor measures faults in the wheel or the track. The wheelset bearing sensor measures failures of a weld or break in the track or a break or gap in the track. The wheelset bearing sensor detects such faults or failures by measuring vertical vibration of the wheel over time.

In an embodiment, as illustrated in FIG. 6D, one common wheel (or tire) fault is a flat spot (caused when braking hard). The wheelset sensor detects such flat spots by measuring for the vertical acceleration on the wheel and monitoring for values above or below a noise threshold 652 (above ˜0.75 m/s\hat{ }2 in this example of FIG. 6D). As illustrated in FIG. 6D, breaks in the rail may cause similar spikes in acceleration. In the example of FIG. 6D, the researcher simulated a rail fault which was detected by the same algorithm (threshold over the non-fault acceleration). Periodicity (frequency) of the spikes is also important—wheel faults may show up repeatedly every wheel rotation, rail fault spikes may appear (probably) once per wheel rotation, showing up in multiple wheels as the wheels pass over the fault.

In an embodiment, as illustrated in FIG. 6E, to (4) detect a misaligned geometry of the track in contact with the train, the wheelset bearing sensor measures horizontal motion or axial vibration along an axle (or axis) 410 of wheelset 404 itself. As illustrated in FIG. 6E, similar to detecting wheel flats or track breaks, misaligned tracks 662 bump the wheelset 404 in the horizontal direction with a side force 668 causing abnormal acceleration. Such bumps may be detected by crossing a threshold value for horizontal acceleration, where the threshold itself may also be a function of the train speed. As illustrated in FIG. 6E, a side force 668 may be generated, and a higher side force 668 is considered abnormal. In an embodiment, flanges contact the rail if the train is wobbling back and forth.

In an embodiment, as illustrated in FIG. 6F, to (5) detect a derailment 672 of a wheelset 404 or to (6) detect a failure of an axle (or axis) 410 of the wheelset 404, the wheelset bearing sensor measures (i) vertical vibration 678 over time, (ii) horizontal vibration 676 over time, or (iii) both vertical and horizontal vibration (678, 676, respectively) over time. The wheelset sensor may also (iv) measure wheelset rotation speed changes over time. As a result of completing such measurements (e.g., one or more of (i), (ii), (iii), or (iv)), the wheelset bearing sensor detects changes in derailment or failure of a rail. In an embodiment, the wheelset bearing sensor detects a failure by monitoring for levels of vibration and determining whether those levels of vibration exceed a threshold. According to some embodiments, the threshold may be a static threshold (e.g., level) or a dynamic threshold (e.g., may change over time). The dynamic threshold may dynamically change based upon one or more variables including but not limited to speed of train, temperature, train length or other variables known to one skilled in the art.

In an embodiment, as illustrated in FIG. 6F, a derailed wheelset 672 may experience very high levels of horizontal vibration 678 and vertical vibration 676, which the wheelset sensor may detect. In some embodiments, the wheelset sensor can also compare the rotational speeds between multiple wheelsets across cars to confirm the derailed wheel is rotating slower or slipping more than the wheelsets still on the track.

Some embodiments may include various other capabilities (shown and described at least in FIG. 6A and FIGS. 9A-B to follow). According to some embodiments, wheelset bearing sensor may include a housekeeping battery (which may be used to maintain data used when not in motion). According to some embodiments, the wheelset bearing sensor may run a full cellular radio with significant processing power.

In other embodiments, sensors can connect in a mesh to a single radio. Mesh networking provides a way for multiple devices to share one internet connection. In some embodiments, some devices may have a connection to a local mesh and some devices may have a connection to the network. The mesh may be formed by low-power radios that handle routing data to and from the network.

According to some embodiments, the method (and system) may provide an improved signal or noise location for vibration, rotation, temperature or a global positioning system (GPS). Vibration may include but is not limited to vibration of high frequencies from track, wheel, or bearing faults, and may enable advanced failure prediction. According to some embodiments, the method (and system) may measure axle rotation thereby enabling odometry or detection of slippage from locked brake conditions. With regard to temperature, the method (and system) of some embodiments may handle a bearing failure that may result in overheating or lockup in thirty seconds or less, for which existing approaches (having sparse monitoring, trackside system “hotboxes”) are inapplicable. In some embodiments, for GPS, bearing caps may face outwardly and may acquire the GPS for precise time keeping or location tracking. According to some embodiments, the method (and system) may provide flexible deployment, as bearings may be replaced (or refurbished) at regular intervals, and repair shops may install bearings during a re-qualification process.

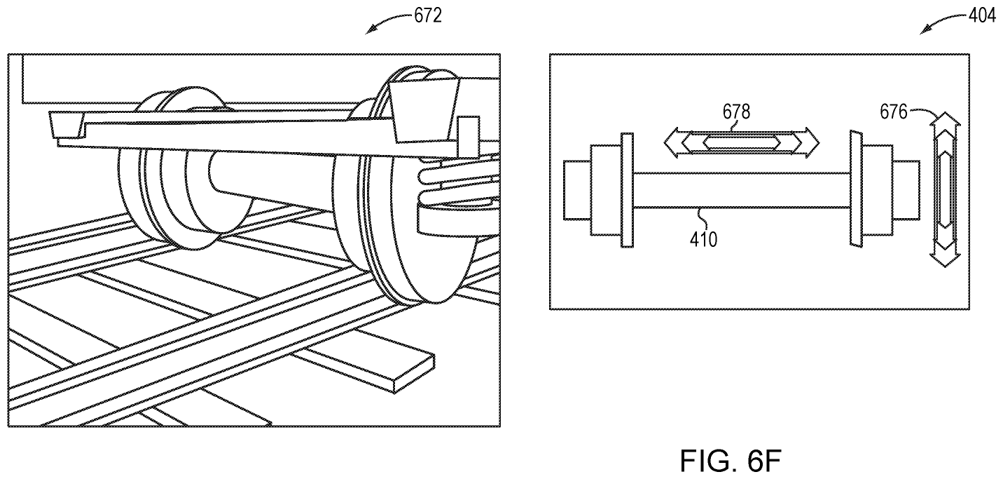

FIG. 7 is a diagram 700 illustrating a wheelset sensor 730 and its various subsystems employed by embodiments of the present disclosure. Such subsystems may include the following: (1) bearings 730 that can be deployed incrementally to any car during routine maintenance; (2) bearing temperature monitoring 710 (or recording) that may provide early warnings before failure in service; (3) vibration monitoring 712 (or recording) that may detect track breaks when they occur; (4) usage monitoring 714 that may monitor or record miles travelled or speed profiles of the train; (5) location monitoring 716 that may improve asset allocation and utilization; (6) cellular data linking 718, which is advantageous because cellular data may be widely available and may not require a high cost infrastructure; (7) cloud data analytics 720 that may detect track or car condition monitoring across the network (including the cloud service or network 608 of FIG. 6); or (8) any other subsystems, as known to one skilled in the art.

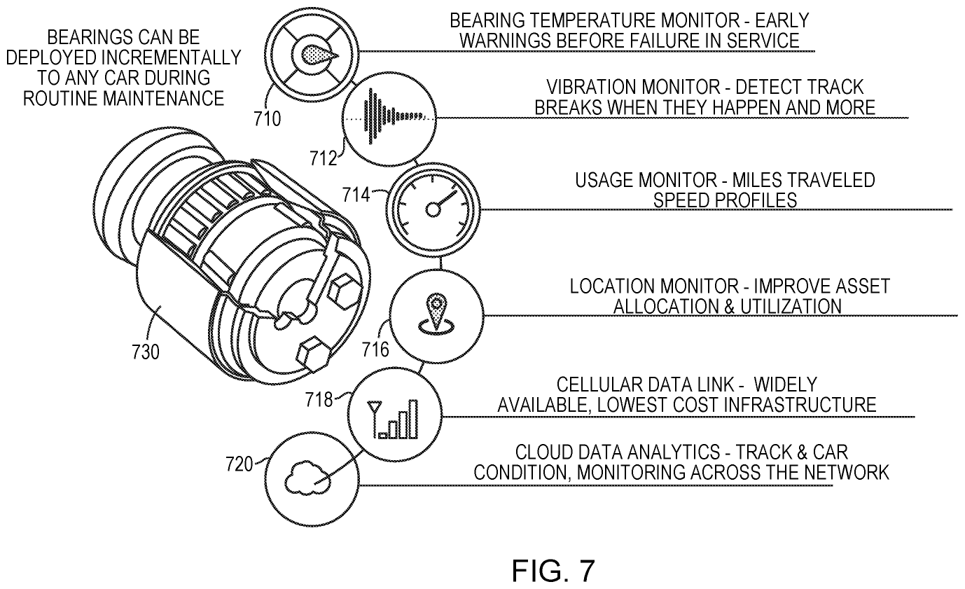

FIG. 8 is a flow diagram illustrating an example embodiment of the present invention. As illustrated in FIG. 8, the method 800 may measure 802 data points within (or on) a wheelset environment 120 of FIG. 1. Next, the method 800 may compare 804 a signature of the data points of the wheelset environment 120 of FIG. 1 to an expected signature. Next, the method 800 may determine 806 a condition 130 of FIG. 1 within the rail environment 140 (of FIG. 1) responsive to the comparison of the signature to the expected signature. In addition, the method 800 may optionally correlate 808 the expected signature to location data 808. Further, the method 800 may optionally diagnose 810 one or more faults within the wheelset environment 120 (of FIG. 1) associated with one or more of the sensors 126 (of FIG. 1).

In some embodiments, the condition may be a fault within the rail environment. The condition may include an actual failure (e.g., an existing failure or a failure that has occurred), a potential failure, or the signature deviating from the expected signature over a threshold. The potential failure may include one or more of a recommendation of maintenance and predicted failure.

In some embodiments, the fault within the rail environment may include one or more of a failure of a bearing of the wheelset, a failure of a wheel of the wheelset, a failure of a rail or weld of a track in contact with the train, a misaligned geometry of the track in contact with the train, a derailment of a wheelset, or a failure of an axle of the wheelset.

In some embodiments, the data points of the wheelset may include one or more of: an acoustic signal (e.g., sound signal level), a vibration signal (e.g., acceleration or vibration level), a rotation (e.g., orientation, rotational signal, or rotational rate) of an axle of the wheelset, a temperature, an atmospheric pressure, a time, a location (e.g., geographic location) of the wheelset; and a velocity (or speed) of the wheelset. In some embodiments, the wheelset environment may include a history of one or more of the data points.

In some embodiments, the method 800 may correlate the expected signature to location data. In some embodiments, the method 800 may diagnose one or more faults within the wheelset environment associated with one or more sensors. The method 800 may perform the measuring by the one or more sensors. The method 800 may perform the diagnosing based upon loss of at least one message or signal sent to or received from an external source.

In some embodiments, the method 800 may harvest power based upon a rotation of an axle of the wheelset. The harvested power may enable one or more of the measuring, the comparing, the communicating, and the determining. In some embodiments, the method 800 may harvest power based upon a self-contained power generator enclosed within a housing (e.g., bearing end cap) of a bearing of the wheelset. In some embodiments, the method 800 may harvest power based upon a power generator comprised of a rotor (e.g., magnets) and a stator (e.g., coils). The rotor and stator may be included in an outer housing of a bearing of the wheelset. According to some embodiments, scavenging power from the rotation of the axle may be a novel advantage compared with existing approaches. According to some embodiments, scavenging power may solve the problem of how to deploy a device for years without the need to replace or recharge batteries.

FIGS. 9A-B are diagrams illustrating example embodiments of power harvesting. By contrast with existing approaches, bearings 910, 920 may use rotational energy from train axles to generate power. In other words, rotation of an axle may provide a source of energy (e.g., energy scavenging).

As illustrated collectively in FIGS. 9A-B, harvesting power may be based upon one of or both of: (i) FIG. 9A—a self-contained power generator 910 (coils 914, and rotor 918, collectively) enclosed within the bearing end cap (950); and (ii) FIG. 9B—a bearing-integrated power generator 920 comprised of a rotor 926 (e.g., magnets) and a stator 922 (e.g., coils). FIGS. 9A-B also illustrate other standard bearing components, such as an end cap 950, outer casing 916, and bolts 912 to hold the end cap 950 in place on the bearing.

FIG. 9A illustrates an end-cap generator 910. The end-cap generator 910 can be added to existing bearings. Some embodiments embed a generator 910 with an offset pendulum. Rotation of the end cap 950 (train motion) results in generator power.

As illustrated in FIG. 9B, the bearing-integrated power generator 920 embed a rotor 926 (magnets) in the outer housing 916 of the bearing and a stator 922 (coils) in the end-cap 950 of the bearing. As train motion rotates the end cap 950, the rotor 926 is activated and power is generated.

In some embodiments, the use of such rotational energy is considered to be an advantage over existing approaches, at least as applied to freight cars that may not have the same types of wheelsets as locomotives.

In some embodiments, the method may harvest power based upon a rotation of an axle of the wheelset. The harvested power may enable measurements, determinations, or comparisons associated with the method (and system), according to some embodiments. In some embodiments, the method may harvest power based upon one or more approaches: (1) a first approach 910 including at least a self-contained power generator 914 included in a housing 916 of a bearing of the wheelset; or a second approach 920 including one or more stators 928 (of FIG. 9B) included in an outer housing 926 of a bearing of the wheelset.

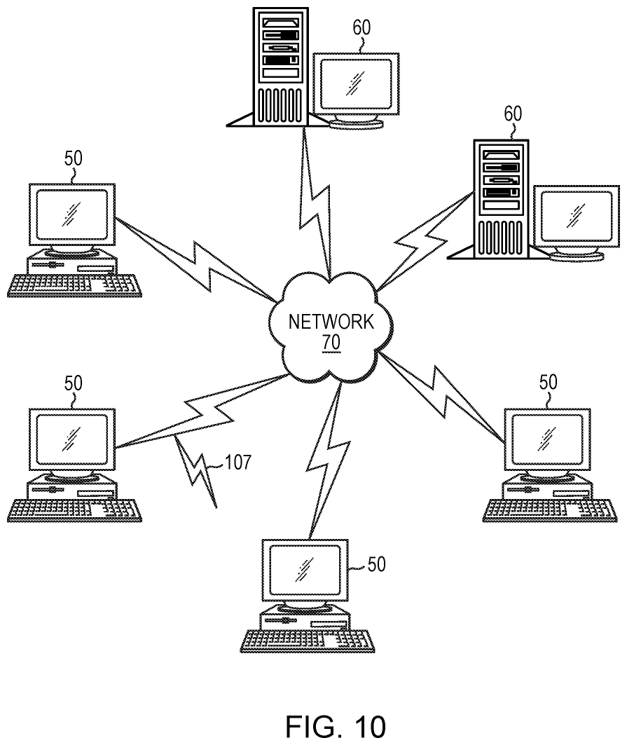

According to some embodiments, some advantages of the first approach 910 are that the method (and system) may implement the first approach 910 at the end cap 918, thereby reducing required design changes to the end cap 918, and simplifying retrofitting existing bearings easy. According to some embodiments, some advantages of the second approach 920 are that the method (and system) may implement the second approach 920 as integrated with the bearing, by having the stator 928 embedded in the outer housing 926 of the bearing, or having rotor pickups on the end cap 930, thereby not requiring any additional moving parts, or providing high power (according to some embodiments, a higher power than in the first approach 910). FIG. 10 illustrates a computer network or similar digital processing environment in which embodiments of the present disclosure may be implemented.

Client computer(s)/devices 50 (e.g., computing devices/display devices) and server computer(s) 60 (e.g., a Cloud-based service) provide processing, storage, and input/output devices executing application programs and the like. The client computer(s)/devices 50 (e.g., computing devices/display devices) can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, BLUETOOTH™, etc.) to communicate with one another. Other electronic device/computer network architectures are suitable.

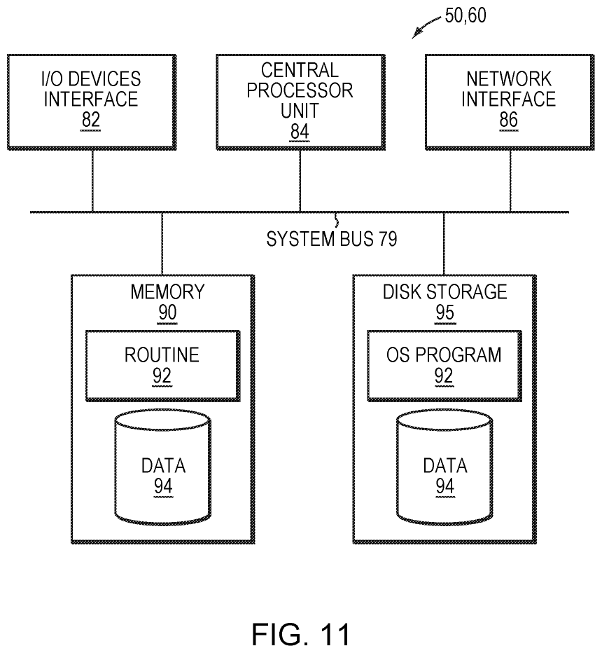

FIG. 11 is a diagram of an example internal structure of a computer (e.g., client processor/device 50 or server computers 60) in the computer system of FIG. 10. Each computer 50, 60 includes a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, touchscreen etc.) to the computer 50, 60. A network interface 86 allows the computer to connect to various other devices attached to a network (e.g., network 70 of FIG. 10). Memory 90 provides volatile storage for computer software instructions 92 and data 94 used to implement an embodiment 100 of the present disclosure (e.g., any of the first processing unit, second processing unit, any sensor or sensors described herein, processor, memory, energy harvesting module, bearing, power generator, self-contained power generator, stator, or any other device, system, module, or controller described herein). Disk storage 95 provides non-volatile storage for computer software instructions 92 and data 94 used to implement some embodiments of the present disclosure. Note, data 94 may be the same between a client 50 and server 60, however, the type of computer software instructions 92 may differ between a client 50 and a server 60. A central processor unit 84 is also attached to the system bus 79 and provides for the execution of computer instructions.

In one embodiment, the processor routines 92 and data 94 are a computer program product (generally referenced 92), including a computer readable medium (e.g., a removable storage medium such as one or more DVD-ROM' s, CD-ROM's, diskettes, tapes, etc.) that provides at least a portion of the software instructions for the disclosure system. Computer program product 92 may be installed by any suitable software installation procedure, as is well known in the art. In another embodiment, at least a portion of the software instructions may also be downloaded over a cable, communication or wireless connection. In other embodiments, the disclosure programs are a computer program propagated signal product 107 (shown in FIG. 10) embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present disclosure routines/program 92. Embodiments or aspects thereof may be implemented in the form of hardware (including but not limited to hardware circuitry), firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, or some combination thereof, and, thus, the data processors described herein are intended for purposes of illustration only and not as a limitation of the embodiments.

While this disclosure has been particularly shown and described with references to example embodiments thereof, it will be understood by those skilled in the art that various changes in form and details may be made therein without departing from the scope of the disclosure encompassed by the appended claims.

Some embodiments may provide one or more technical advantages that may transform the behavior or data, provide functional improvements, or solve a technical problem. In some embodiments, technical advantages (or functional improvements) may include but are not limited to improvement of efficiency, accuracy, speed or other effects compared to the existing methods. Some embodiments provide technical advantages (or functional improvements) in that they overcome functional deficiencies of existing methods. Some embodiments include technical advantages that include but are not limited to performance improvement or scalability compared with existing approaches.

According to some embodiments, other technical advantages (or functional improvements) may include but are not limited to the following. Some embodiments may provide a technical advantage (or functional improvement) by placing the electronics (or system) including but not limited to measurement sensors or computing, directly within a bearing. A technical advantage (or functional improvement) of some embodiments is that direct measurement of high frequency vibrations or acoustics at the wheel may allow predictive analytics for a wide variety of conditions (and the uses may increase over time).

According to some embodiments, a technical advantage (or functional improvement) may be achieved by scavenging power from the rotation of the axle, which may be a novel advantage compared with existing approaches. According to some embodiments, scavenging power may solve the problem of how to deploy a device for years without the need to replace or recharge batteries.

In some embodiments, a technical advantage (or functional improvement) may be achieved by the use of rotational energy and may considered to be an advantage over existing approaches, at least as applied to freight cars that do not have the same types of wheelsets as locomotives.

Some embodiments solve a technical problem (thereby providing a technical effect) by one or more of the following. Some embodiments may solve a technical problem (thereby providing a technical effect) by placing the electronics (or system) including but not limited to measurement sensors or computing, directly within a bearing. A technical problem solved (thereby providing a technical effect) of some embodiments is that direct measurement of high frequency vibrations or acoustics at the wheel may allow predictive analytics for a wide variety of conditions (and the uses may increase over time).

According to some embodiments, a technical problem solved (thereby providing a technical effect) may be achieved by scavenging power from the rotation of the axle, which may be a novel advantage compared with existing approaches. According to some embodiments, scavenging power may solve the problem of how to deploy a device for years without the need to replace or recharge batteries.

In some embodiments, a technical problem solved (thereby providing a technical effect) may be achieved by the use of rotational energy and may considered to be an advantage over existing approaches, at least as applied to freight cars that do not have the same types of wheelsets as locomotives.

The teachings of all patents, published applications and references cited herein are incorporated by reference in their entirety.

What is claimed is:

1. A method comprising:
measuring data points within a wheelset environment, the wheelset environment local to a wheelset of a train;
comparing a signature of the data points of the wheelset environment to an expected signature, the expected signature representing a baseline of normal operations within a rail environment; and
determining a condition within the rail environment responsive to the comparison of the signature to the expected signature.

2. The method of claim 1, further comprising communicating the determined condition to one or more devices across a network.

3. The method of claim 1, wherein the condition is a fault within the rail environment, the condition including any of:
an actual failure;
a potential failure, the potential failure including one or more of a recommendation of maintenance and predicted failure; and
the signature deviating from the expected signature over a threshold.

4. The method of claim 3, wherein the fault within the rail environment includes at least one of:
a failure of a bearing of the wheelset;
a failure of a wheel of the wheelset;
a failure of a rail or weld of a track in contact with the train;
a misaligned geometry of the track in contact with the train;
a derailment of a wheelset; and
a failure of an axle of the wheelset.

5. The method of claim 1, wherein the data points of the wheelset environment include at least one of:
an acoustic signal;
a vibration signal;
a rotation of an axle of the wheelset;
a temperature;
an atmospheric pressure;
a time,
a location of the wheelset; and
a velocity of the wheelset.

6. The method of claim 5, wherein the wheelset environment includes a history of one or more of the data points.

7. The Method of claim 1, further comprising at least one of:
diagnosing one or more faults within the wheelset environment associated with one or more sensors, the measuring being performed by the one or more sensors, the diagnosing being performed based upon loss of at least one message or signal sent to or received from an external source; and
correlating the expected signature to location data.

8. The method of claim 1, further comprising harvesting power based upon a rotation of an axle of the wheelset, the harvested power enabling one or more of the measuring, the comparing, the communicating, and the determining.

9. The method of claim 8, wherein harvesting power is based upon at least one of:
a self-contained power generator enclosed within a housing of a bearing of the wheelset; and
a power generator comprised of a rotor and a stator in an outer housing of a bearing of the wheelset.

10. A system comprising:
a sensor configured to measure data points of a wheelset environment, the wheelset environment local to a wheelset of a train;
a processor; and
a memory with computer code instructions stored therein, the memory operatively coupled to said processor such that the computer code instructions configure the processor to implement:
comparing a signature of the data points of the wheelset environment to an expected signature, the expected signature representing a baseline of normal operations within a rail environment; and
determining a condition within the rail environment responsive to the comparison of the signature to the expected signature.

11. The system of claim 10, wherein the processor is further configured to communicate the determined condition to one or more devices across a network.

12. The system of claim 10, wherein the condition is a fault within the rail environment, the condition including any of:
an actual failure;
a potential failure, the potential failure including one or more of a recommendation of maintenance and predicted failure; and
the signature deviating from the expected signature over a threshold.

13. The system of claim 12, wherein the fault within the rail environment includes at least one of:
a failure of a bearing of the wheelset;
a failure of a wheel of the wheelset;
a failure of a rail or weld of a track in contact with the train;
a misaligned geometry of the track in contact with the train;
a derailment of a wheelset; and
a failure of an axle of the wheelset.

14. The system of claim 10, wherein the data points of the wheelset environment include at least one of:
an acoustic signal;
a vibration signal;
a rotation of an axle of the wheelset;
a temperature;
an atmospheric pressure;
a time;
a location of the wheelset; and
a velocity of the wheelset.

15. The system of claim 14, wherein the wheelset environment includes a history of one or more of the data points.

16. The system of claim 10, wherein the processor is further configured to perform at least one of:
correlating the expected signature to location data; and
diagnosing one or more faults within the wheelset environment associated with one or more sensors, the measuring being performed by the one or more sensors, the diagnosing being performed based upon loss of at least one message sent to or received from an external source.

17. The system of claim 10, further comprising an energy harvesting module configured to harvest power based upon a rotation of an axle of the wheelset, the harvested power enabling one or more of the measuring, the comparing, the communicating, and the determining.

18. The system of claim 17, wherein the harvesting power is based upon at least one of:
a self-contained power generator enclosed within a housing of a bearing of the wheelset; and
a power generator comprised of a rotor and a stator in an outer housing of a bearing of the wheelset.

19. A non-transitory computer-readable medium configured to store instructions for determining a condition within a rail environment, the instructions, when loaded and executed by a processor, causes the processor to:
measure data points of a wheel set environment, the wheelset environment local to a wheel set of a train;
compare a signature of the data points of the wheelset environment to an expected signature, the expected signature representing a baseline of normal operations within the rail environment; and
determine the condition within the rail environment responsive to the comparison of the signature to the expected signature.

20. The non-transitory computer readable medium of claim 19, wherein the condition is a fault within the rail environment, the condition including any of:
an actual failure;
a potential failure, the potential failure including one or more of a recommendation of maintenance and predicted failure; and
the signature deviating from the expected signature over a threshold.
